(19) United States
(12) Patent Application Publication
(10) Pub. No.: US 2007/0088695 A1
(43) Pub. Date: Apr. 19, 2007

(54) Method and apparatus for identifying documents relevant to a search query in a medical information resource

(75) Inventors: Piet Bleyendaal, Waltham, MA (US); Denise Basow, Southborough, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: UpToDate Inc., Waltham, MA (US)

(21) Appl. No.: 11/580,755

(22) Filed: Oct. 13, 2006

Related U.S. Application Data
(60) Provisional application No. 60/727,271, filed on Oct. 14, 2005.
(60) Provisional application No. 60/756,743, filed on Jan. 6, 2006.

(51) Int. Cl. G06F 17/30

(52) U.S. Cl. 707/5

(57) ABSTRACT

A computerized system and method for providing information for use in medical care. Documents in a medical information resource may have several associated sections, such as title, headings, text, keyword and document type sections. Display of search results resulting from a user's query may be determined based on at least one document section in which the search engine identifies at least one search term. The search engine may generate a set of search terms for identifying documents relevant to a user's query, at least in part, by using a search term synonym resource that includes a plurality of search terms arranged in groups of associated synonyms. Synonyms in an associated group may be arranged in a hierarchical structure such that each synonym in the associated group has a parent, sibling or child relationship with each other synonym in the associated group.

### BACKGROUND OF INVENTION

When users perform a computerized search for information, there are many things that can keep them from finding useful information. Spelling mistakes, incorrect use of Boolean terms, vocabulary mismatches, and other issues can render the results of a search useless. Even if a user is extremely meticulous and knowledgeable, it is still not certain that the user will find available and relevant information.

For a computerized search, typically the relevant corpus has already been indexed based on the words found in each document within the corpus. When a user inputs a term or set of terms into a search engine's interface, the search engine looks for the search term(s) in the appropriate index(es) and, usually using some proprietary algorithm, determines which documents in the corpus appear to be relevant to the user's query. The search engine then presents to the user a list of the relevant results, typically hyperlinked to the appropriate documents in the corpus. For example, a search on a corpus containing information about books might return a list of titles, hyperlinked to the corpus entries for those titles.

Once the list of results is presented, it is up to the user to choose the document that contains relevant information she is seeking. Presuming that effective search terms were entered and that the corpus does indeed contain the sought-after information, finding the information should be a simple matter of choosing a result from the list of relevant results and following the related hyperlink.

In practice, however, it may be unclear which item in a list contains information relevant to the user's intended search. Thus, designers of various search engines have incorporated features and techniques to make it easier for a user to tell which results may be useful. Techniques include:
adding a relevance metric for each result (such as percent relevance, or frequency of search term appearances in the referenced document);
ranking search results, for example, based on their relevance to the search term(s), frequency of search term appearances in the document, or the number of external links to the document;
categorizing search results so that, for example, users can choose entries for “python” that refer to snakes versus those that refer to a programming language; and
listing a portion of each relevant document along with each result so that users can read a bit of each entry to determine whether or not it appears to be useful.

### SUMMARY OF INVENTION

In describing a system for presenting computerized search results that incorporates aspects of the invention, we use as an example the UpToDate medical information resource (www.uptodate.com). However, the features described may be used in a variety of search applications.

UpToDate is an evidence-based clinical information resource designed to provide concise, practical answers to physicians at the point of care. Content within UpToDate's corpus is organized into documents within specialty areas and may include text, tables, graphics, animations, or other formats. Within documents, text and other content may be organized into sections and/or paragraphs, such as by diagnosis, treatment, differential diagnosis, pathophysiology, etiology, or other relevant headings.

To perform a search in UpToDate, a user may input a term or set of terms into a search box in UpToDate's search interface and click a Search button. Information retrieval software then searches UpToDate's database for entries containing the search terms and returns an ordered list of relevant results.

In accordance with aspects of the invention, each UpToDate document follows a particular structure, containing specific sections relating to a title, headings and graphics (which may be used to create an outline), and text. In addition, keywords may be assigned to the document in one or more keyword groups, and documents may be assigned as belonging to one or more document types. Together, these different sections make up a document's structure, and the presence of searchable terms in each section of the document structure can affect the results of a user's search in varying ways. For example, if a user enters a search term that appears in the title section of a document, this may factor in and cause the document to appear higher on the results list than other documents. Accordingly, the different document sections can be leveraged to present the user with more precise search results.

In one aspect of the invention, a medical information system may search a database of documents related to providing medical care and return a list of at least one relevant document, where a plurality of documents in the database include searchable sections including a title, headings, text, a set of keywords, and a document type. Keywords for each document may be assigned by one or more human experts, e.g., to help better define the content of the document. Similarly, the document type(s) may be hand-selected and may define that the document relates to guidelines for providing medical care, an overview of a related medical topic, providing patient information for a related medical topic, relate to a drug or drugs, and/or relate to pediatric care. When searching, the system may identify where search terms are located in the section(s) and the relevance of the document to the search query (and therefore prominence in the results display of the document) may be determined based on such information.

In another aspect of the invention, a search term in a user's search query may be identified as a drug or relating to a drug. This may cause drug-related documents to be given priority in the search and results display. For example, the document type field for a document may include a “drug” designation, indicating that the document relates to a drug. Thus, if the drug-related search term is found in a document having a “drug” type indicator, that document may be identified as more relevant than documents that include the term, but are not “drug” related.

In another aspect of the invention, the medical information system may use a vocabulary of medical terms that are used in searching documents stored in a medical information resource. The vocabulary may include multiple sets of synonyms, and each set of synonyms may include a canonical term (a highest level parent term that generically defines the set), and associated child synonym terms. Thus, the synonyms may be arranged in a hierarchical structure with two or more levels, where each level may include one or more terms. (Synonym terms at the same hierarchical level are termed “siblings.”) The synonym groupings may be determined by a panel of human experts in the relevant field, and may reflect an editorial judgment that certain terms are closely related to each other. In one aspect of the invention, k-stemming or other suitable techniques may be used to expand the membership in a group of synonyms.

In one aspect of the invention, when a child synonym term is included in a user search query, the system may suggest that a broader term (the canonical term or other parent term to the child as defined in the child's synonym group) be used instead. Also, if a user search query includes a term that is ambiguous, e.g., has two or more meanings, is a misspelled word, or has no understood meaning for the system, the system may take various action. If the term has multiple meanings (e.g., is associated with two or more synonym groups), a preferred meaning for the term may be automatically selected and used in searching. Alternately, the system may prompt the user to select which meaning to use, or authorize the use of the preferred meaning. Misspellings may be identified, e.g., using a spell checker program, and alternates may be suggested for selection by the user. Terms having no understood meaning (e.g., terms not found in the vocabulary even after a spell check operation) may be used to search the documents, e.g., for exact matches for the term.

In another aspect of the invention, a computerized medical information system includes a medical information resource including a plurality of documents, where each of the documents relates to providing medical care for a patient. A document searching index may be provided that includes information for each of the plurality of documents and is used for searching and identifying documents that are relevant to a search query. The information for each of the documents may include document words that are located in sections of the document including title, headings, keywords, text and document type sections. A search engine may receive a search query from a user, generate a set of search terms from the search query, and then use the set of search terms and the document searching index to identify documents that relate to the search query. A search results module may provide a display of search results to the user based on documents identified by the search engine, and may rank documents in the display of search results based on at least one document section in which the search engine identified at least one term from the set of search terms. Thus, the search results module may determine that certain documents are more relevant to a search query based on where search terms are located relative to various document sections. For example, a document including a search term in the title section or keyword section may be determined to be more relevant than a document including the same search term in the body text of the document.

In one embodiment, each of the plurality of documents may have a plurality of keyword sections, e.g., four keyword sections. The document type section may include an indication regarding a guideline type, an overview type, a patient information type, a drug type and/or a pediatric type. In another embodiment, at least one term included in the keyword information for each of the plurality of documents is selected by a human expert panel.

In another embodiment, the search results module may use boost factors for each of the document sections to rank documents in the display of search results. For example, the boost factors may increase or decrease a relevance measure regarding the identification of a search term in a particular document section. Thus, in one case, a boost factor may provide a higher multiplier for an instance in which a search term is found in a keyword section, than in a text section. The search engine may be automatically tuned by iteratively stepping (e.g., adjusting) boost factors for the different document sections so as to improve the accuracy of the search results provided to the user.

In another aspect of the invention, a computerized medical information system includes a medical information resource including a plurality of documents, where each of the documents relates to providing medical care for a patient. A document searching index may be provided that includes information for each of the plurality of documents and is used for searching and identifying documents that are relevant to a search query. A search engine may receive a search query from a user, generate a set of search terms from the search query, and then use the set of search terms and the document searching index to identify documents that relate to the search query. The search engine module may include a search term synonym resource that has a plurality of search terms arranged in groups of associated synonyms. Synonyms in an associated group may be arranged in a hierarchical structure such that each synonym in the associated group has a parent, sibling or child relationship with each other synonym in the associated group. The search engine may use the search term synonym resource to identify at least one synonym search term that is associated as a synonym with at least one term in the search query, e.g., provided by a user. The search engine may include the synonym search term in the set of search terms that is used to identify documents relevant to the search query. Thus, for example, if a search query includes the term “antiplatelet agent,” the search engine may identify a set of related synonym search terms (e.g., which includes the term “aspirin”), and include not only “antiplatelet agent” in the set of search terms, but also other synonyms, such as “aspirin.” A search results module may provide a display of search results to the user based on documents identified by the search engine. The groups of associated synonyms and the hierarchical structure for each associated group may be defined by a human expert panel, e.g., a group of expert physicians.

In one embodiment, the search engine may include in the set of search terms only sibling and child synonyms for a term in the search query. For example, if the search query includes the term “antiplatelet agent”, the search engine may identify child synonyms for the “antiplatelet agent” term, e.g., “aspirin,” and include the child synonyms in the set of search terms used to identify relevant documents.

In another embodiment, the search engine may suggest the use of a parent synonym in the set of search terms when the search query includes a term that is identified to be a child synonym of the suggested parent synonym. For example, if a search query includes the term “aspirin”, the search engine may suggest the use of “antiplatelet agent” in the set of search terms used to identify relevant documents.

These and other aspects of the invention will be obvious and/or apparent from the following description. Various aspects of the invention may be used alone or in any suitable combination.

### BRIEF DESCRIPTION OF THE DRAWINGS

Aspects of the invention are described below with reference to illustrative embodiments shown in the figures in which like numerals reference like elements, and in which:

FIG. 1 shows a schematic view of a system for providing medical information in accordance with aspects of the invention;

FIG. 2 shows an illustrative graphical user interface displaying a search result;

FIG. 3 shows an illustrative graphical user interface displaying an outline and a related topic document;

FIG. 4 shows an illustrative graphical user interface displaying additional terms for a search query;

FIG. 5 shows an illustrative graphical user interface displaying a preferred meaning for a search term and alternate meanings;

FIG. 6 is a schematic diagram illustrating the building of a document searching index, searching the index and providing search results;

FIG. 7 is a flowchart of steps in a method for establishing a document searching index and search engine vocabulary as well as searching for documents relevant to a search query;

FIG. 8 shows steps in a method for building a document searching index;

FIG. 9 shows steps in a method for generating a set of search terms for use in identifying relevant documents; and

FIG. 10 shows steps in a method for setting boost factors for generating search results.

### DETAILED DESCRIPTION

Various aspects of the invention are described below with reference to specific embodiments. For example, aspects of the invention are described in the context of performing a search and review of results using a medical information resource. However, it should be understood that aspects of the invention are not necessarily restricted to this particular environment. Rather, various aspects of the invention may be used in any suitable system. For example, in describing a system for presenting computerized search results, we use as an example the search function in the UpToDate system. However, the features described may be used in a variety of search applications. In addition, various aspects of the invention may be used alone, and/or in combination with any other aspects of the invention.

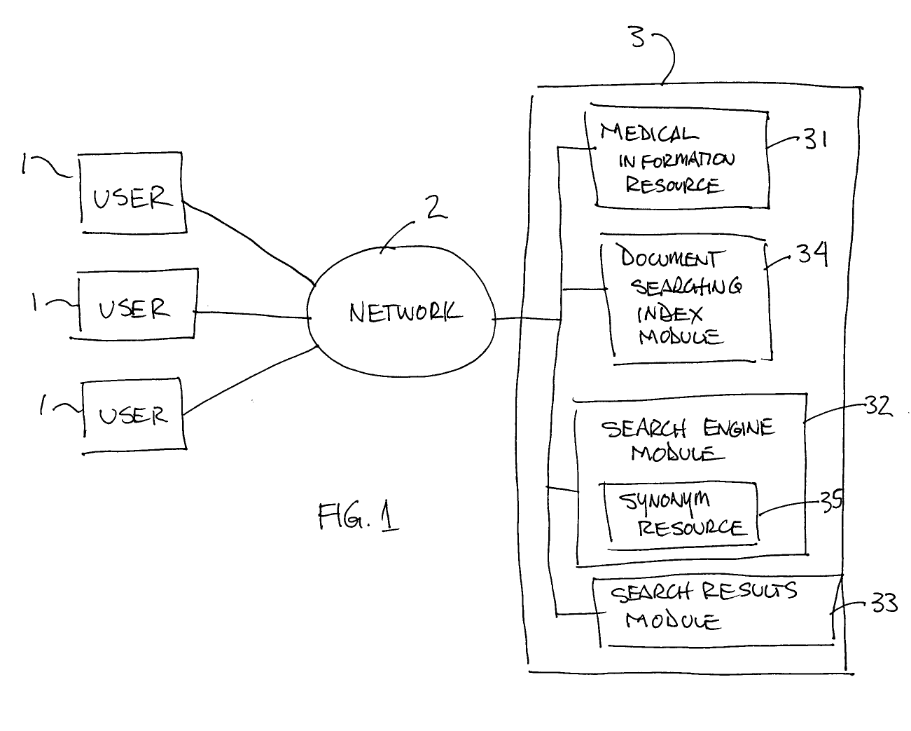

FIG. 1 shows a schematic diagram of a system for providing medical information in accordance with aspects of the invention. Users 1 interact with one or more computers that are linked to a network 2, such as the Internet, a telephone network, a local area network (LAN—whether wired or wireless), any other suitable communication network and/or any combination of such networks and devices. (As used herein, a computer includes, but is not limited to, programmable general purpose computing devices, including laptops, PDAs, electronic writing tablets, network servers, network terminals, and any other suitable device.) A medical information resource system 3 may have one or more computers that also communicate with the network 2 such that users 1 and the medical information resource system 3 may exchange information via the network 2. Users 1 may be individuals, such as doctors and/or other health care providers or other self-directed computer systems, that access the medical information resource system 3 for articles, analysis and/or other information used to assess, treat or otherwise provide care for a patient's medical condition. For example, users 1 may access an Internet website or other arrangement maintained by the medical information resource system 3 to obtain medical information. The website may include a search engine or other interface to allow a user to navigate and locate desired information, such as articles or other content offered by the medical information system 3. It should be understood that the arrangement in FIG. 1 is only illustrative, and that aspects of the invention may be implemented in other environments. For example, aspects of the invention may operate in an environment in which the medical information resource system 3 is located within the user 1 computer, and/or at a local network for the user computer.

One type of medical information provider is UpToDate of Waltham, Mass. (www.uptodate.com), which is referred to in the illustrative embodiments below. UpToDate provides an evidence-based clinical information resource available to clinicians and designed to provide concise, practical answers to physicians at the point of care. Content within UpToDate's corpus is organized into topics within specialty areas and may include text, tables, graphics, animations, and other formats. Within topic documents, text and other content may be organized into sections and/or paragraphs, such as by diagnosis, treatment, differential diagnosis, pathophysiology, etiology, or other relevant headings. Keywords may be associated with portions of the text. As used herein, a “document,” like those used in the UpToDate system, may include any suitable information such as text, figures, charts, diagnosis/treatment flow diagrams, forms, graphs, x-ray and/or any other suitable images (e.g., ultrasound, MRI, PET scan images, etc.), and/or other information useful for providing medical care.

In this illustrative embodiment, the medical information system 3 includes a medical information resource 31, which may include one or more storage devices (volatile and/or non-volatile memory, such as semiconductor memory, magnetic tape or disc drives, optical storage, etc.) on which one or more documents are stored. As mentioned above, each of the documents typically include content relevant to at least one topic related to providing health care, and may include one or more sections of written text, graphics (such as graphs, cartoons, photographs, x-ray or other images, flow charts, decision trees, etc.), video images (such as a video clip presenting a surgical technique, medical condition or other), charts, tables, and/or other information. If the resource 31 includes two or more storage devices, the storage devices need not be located in a common place, but instead may be located in disparate locations such as in several different computers across a local or wide area network. Additionally, all portions of the system 3 need not be located in a common place, but instead may be located in disparate locations such as several different computers across a local or wide area network.

The medical information system 3 may receive a search request from a user (or other computer) in any suitable format to identify one or more documents in the medical information resource 31. For example, the search request may include at least one search term that represents content to be included in a document to be identified in a search result. The criteria may be one or more keywords, an image or portion of an image, a natural language search string, or any other suitable indication of content to be used in identifying documents in the resource 31 that are related to the search criteria. The user may provide the search criteria in any suitable way, such as by entering the criteria into a webpage dialog box viewed using a suitable browser application at the user location. Alternately, the search criteria may be provided in other ways. For example, the user may have a set of search criteria stored by the medical information resource system 3, which implements the search criteria on a periodic basis, e.g., monthly so that the user may get regular updates regarding changes in a particular medical area. In another embodiment, the user 1 may provide a general indication of the information desired, and the system 3 may provide the search criteria used for a search, e.g., in an automated way, and/or a human operator at the medical information system 3 may provide the search criteria manually based on a review of the user request.

Based on the search request, a search engine module 32 may perform an analysis of documents in the medical information resource 31 to identify one or more documents that satisfy the search request, thereby identifying the one or more documents as part of a search result. As used herein, to “satisfy” a search request means that the search request and/or any other suitable search terms, algorithm, etc., are used to identify a document or sections of content related to a document that is suitably similar to, includes, or otherwise is related to the search request criterion. The search engine module 32 may operate in any suitable way to identify documents as part of a search result, such as by keyword identification, keyword proximity detection, content evaluation, reference to a document by other articles or documents, and so on.

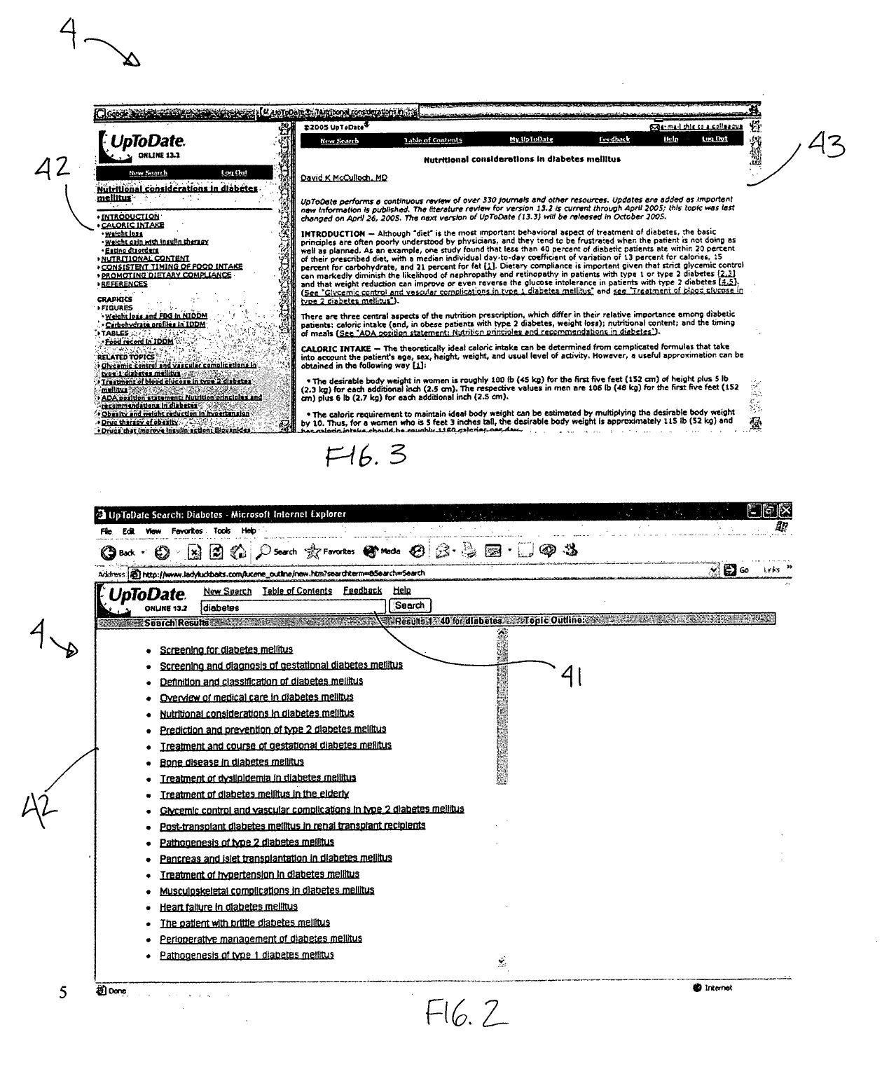

Search results identified by the search engine module 32 may be presented to the user 1 by a search results module 33. For example, the search results module 33 may be adapted to provide a graphical user interface for the user that includes an indication for the documents in the search result. The indication may be arranged in any suitable way to indicate a document to a user. For example, FIG. 2 shows an illustrative graphical user interface 4 in one embodiment of the invention. In this example, the user provided the search criterion “diabetes” in a search request dialog box 41. After performance of a search of documents in the medical information resource 3 in response to the user clicking on the “search” button of the search request dialog box 41, the search results module 33 generated the graphical user interface 4 shown, which includes a listing of document titles in a left pane 42. Indication of search results is not necessarily limited to a title listing. As used herein, a “list” of search results includes a columnar and/or table-like listing of document titles, as well as other concise indication(s) of search results, such as display of an indicator other than (or in addition to) a document title, e.g., a document reference number, author name, associated keywords, an associated graphic, a selected text portion, etc. In this embodiment, the left pane 42 includes a scroll bar so that a user 1 may adjust the left pane 42 so as to view topic titles lower down in the listing. However, it will be understood that the indication of documents provided in the graphical user interface may be arranged in other ways. At this point, the right pane 43 of the graphical user interface 4 is empty, but in other embodiments may include any desired information, such as advertisements, etc.

Each title indication shown in FIG. 2 may be hyperlinked to a document (i.e., a type of document) in the medical information resource 3. Thus, a user 1 may click on an indication and thereafter have the corresponding document displayed on the graphical user interface 4. For example, if a user 1 wants to find information about nutritional considerations in diabetes patients, she might scroll through the list of indications in the left pane 42 of FIG. 2 and follow the hyperlink for the indication “Nutritional considerations in diabetes mellitus.” This may produce a result similar to that shown in FIG. 3, in which the topic title and an outline of the document are displayed in the left pane 42 along with the written text, graphics and other information in the corresponding document in the right pane 43. The outline may include a list of key headings, subheadings, content sections, and/or graphics of interest within a document, and each item in the list may be hyperlinked, allowing users to go directly to a portion of the document that may be of interest. In this graphical user interface 4, the user 1 may select a section in the outline displayed in the left pane 42, thereby causing the corresponding section to be displayed in the right pane 43. This control of the graphical user interface, along with retrieval of information from the resource 3, etc., may be performed by the search results module 33. Once the user 1 has reviewed one or more sections of the document, she might use her browser's “Back” button or other suitable control to go back to the search results list of FIG. 2, where she might follow another document link.

In one aspect of the invention, the search results module 33 may provide a display of search results for a user (e.g., like that in FIG. 2) based on locations in documents where search terms in the set of search terms used by the search engine were found. For example, in this illustrative embodiment, the system 3 may include a document searching index module 34 that includes an index of document words found in or otherwise associated with a document as well as information for each of the documents that indicates where the document words are located with respect to several document sections. In this illustrative embodiment, each document may have several document sections associated with it including a title section, a headings section, one or more keyword section(s), a text section and a document type section. Thus, the document searching index 34 may provide a list of terms (i.e., individual words, phrases, word groupings, symbols, etc.) that are found in the title, in one or more document headings, and in the text body of the document.

The document searching index may also include a list of terms that are found in one or more keyword sections and/or a document type section. Unlike the title, heading and text sections, terms in the keyword sections or document type sections may not actually appear in the document when viewed by a user. Instead, these sections may be normally hidden from user view, and used for searching, display, or other purposes. Terms in the keyword section(s) may be assigned by a human expert panel, i.e., one or more persons who are expert in the relevant medical field and that associate particular terms to the document via the keyword section. A document may have a single keyword section, to which one or more terms may be associated, or may have two or more keyword sections (again, where each section may include two or more terms). The keyword sections may be ranked in a logical sense, e.g., such that terms in Keyword section 1 are deemed to be most relevant to the document, terms in Keyword section 2 are less relevant to the document, and so on.

With respect to the document type section, each document may have a particular term associated with it to indicate a type of document, e.g., to indicate that the document is a “guideline” type document that provides guidelines regarding diagnosis and/or treatment of a related medical condition, an “overview” type document that provides an overview of the relevant medical care topic, a “patient information” type document that provides information suitable for patient review and interpretation regarding a medical condition, a “drug” type that relates to one or more drugs, and a “pediatric” type document that indicates that the document relates to medical care for pediatric patients. Document type information may be useful, e.g., where the search engine determines that the user search query seeks a drug-related reference or a pediatric care-related reference. In such a case, documents having the “type” sought may be ranked more highly in the search results list than other documents.

The search engine module 32 may identify in which section(s) one or more search terms were identified, and based on this information, the search results module 33 may generate a suitable display of the documents identified. For example, documents for which search terms used by the search engine were found in the title section may be ranked higher in the results display than documents for which the same search terms were found in the headings section, the keyword section, or text body section. Documents with a search term found in the keyword section may be ranked higher than documents with the search term found in the headings or text body section, and so on. In addition, analysis of the user query by the search engine module 32 may inform how the search results module 33 ranks documents in the results display. As mentioned above, if the search engine module 32 determines that a search query seeks a “drug” related reference, an “overview” type reference, etc., the search engine module 32 may so indicate to the search results module 33, which may then rank documents having the “document type” sought more highly.

In accordance with an aspect of the invention and as discussed in more detail below, the search results module 33 may use boost factors to refine ranking criteria for the documents identified in a search. For example, individual multipliers may be applied to results of finding a search term in a title section, heading section, and so on. The boost factors may be arranged to fine tune the operation of the search engine module 32 and the search results module 33 given a particular set of documents and typical search queries. For example, a human expert panel may identify several preselected documents that should be identified relatively high in a search results list based on a predefined query. The search engine 32 and search results module 33 may be caused to operate on the document resource 31 using the query and provide a results list. If the preselected documents do not appear sufficiently high in the results list, the boost factors may be adjusted, e.g., using an iterative process that optimizes the operation of the system for the query. This process may be repeated for several preselected document set/search query instances, thereby further refining the boost factors.

In another aspect of the invention, the search engine module may implement a search term synonym resource 35 (see FIG. 1) that includes a plurality of search terms that are arranged in groups of associated synonyms. The synonym resource 35 may be included as part of a search term vocabulary used by the search engine 32. Thus, terms that mean the same thing or approximately the same thing may be logically grouped together by the synonym resource 35. When a user provides a search query including one or more terms, the search engine module 32 may determine if each term in the search query has one or more associated synonym search terms in the synonym resource. If so, the search engine 32 may automatically include one or more of the synonyms and/or inquire with the user whether to include the synonyms or not.

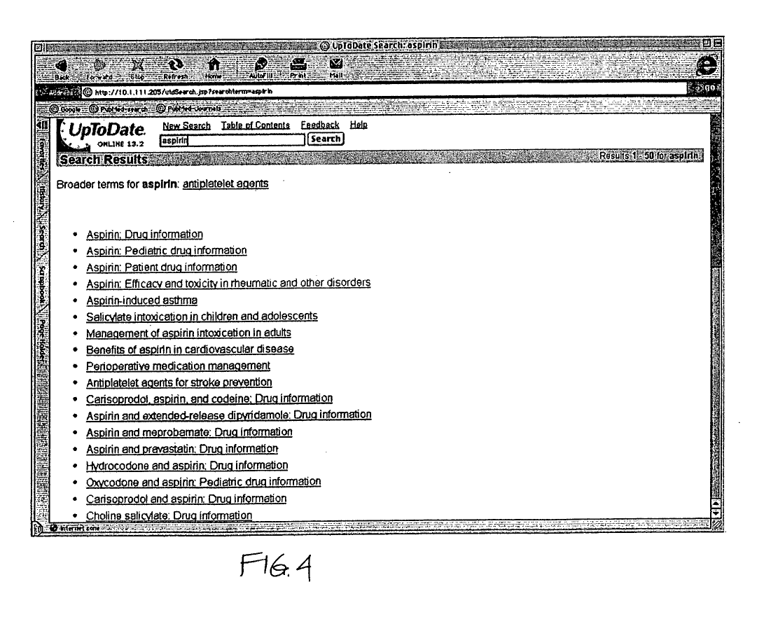

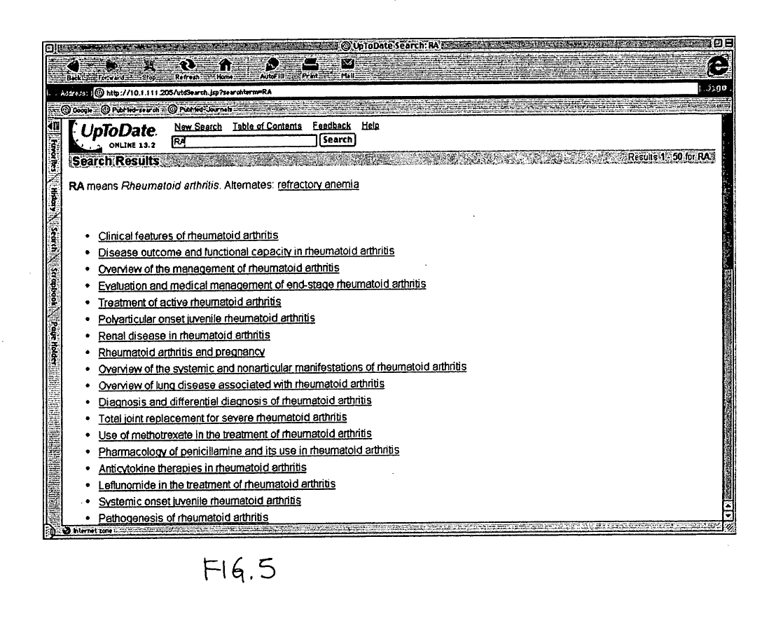

In one illustrative embodiment, one or more groups of synonyms may be arranged to have a hierarchical structure such that each synonym in an associated group has a parent, sibling or child relationship with each other synonym in the associated group. For example, the term “antiplatelet agent” may be a synonym of “aspirin” and additionally may be a parent search term to “aspirin.” If a user provides a search query with the term “aspirin” as shown in FIG. 4, the search engine module 32 may automatically include the term “antiplatelet agent” in the set of search terms used to identify documents in the medical information resource 31, or may inquire with the user whether this term should be included or substituted for the term “aspirin.” In one embodiment, the search engine module 32 may automatically include any child or sibling synonyms for a term included in a search query. For example, if the user provided a search query with the term “antiplatelet agent”, the search engine may automatically include the term “aspirin” (a child synonym to “antiplatelet agent”) in the set of search terms used to identify documents.

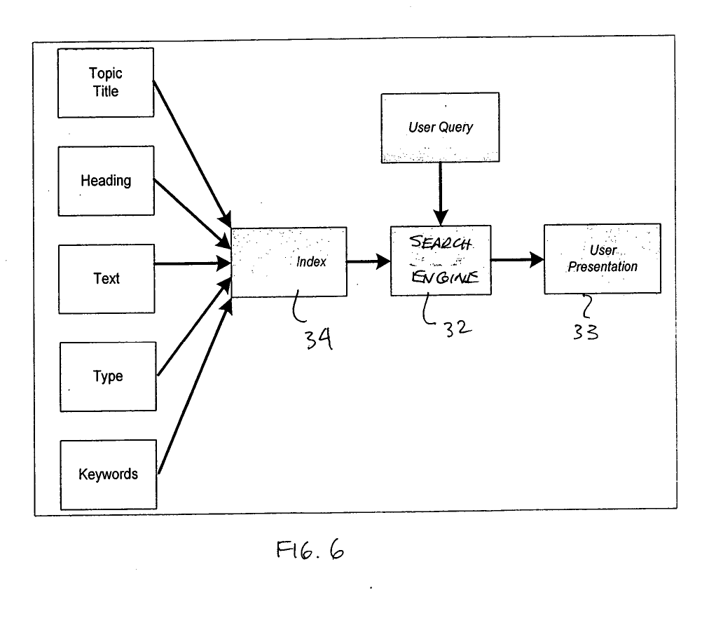

In another embodiment, the synonym resource 35 may be used to identify whether a term included in a user's search query has two or more meanings. As shown in FIG. 5, for example, a user may enter the term “RA” as a search query. The search engine module 32 may then determine what synonyms are associated with “RA.” If two or more different synonym groups are identified (or if the vocabulary used by the search engine 32 indicates two different meanings for “RA”), the search engine module 32 may determine that the term “RA” has two or more meanings, select a preferred meaning for “RA” (in this example, the meaning or synonym “rheumatoid arthritis” is indicated as being the preferred meaning), perform a search, and display the results. As also shown in FIG. 5, the search results module 33 may display the meaning used in the search, along with alternate meanings/synonyms that were not used, but may be selected by the user (e.g., “refractory anemia”).

Below, a detailed explanation of an embodiment incorporating aspects of the invention is provided with reference to the UpToDate medical information resource system. However, as mentioned above, aspects of the invention may be used in other environments.

The UpToDate system in this embodiment uses a search term vocabulary that includes about 30,000 medical terms (words, phrases, symbols, etc.) and 80,000 synonyms for those terms that have been selected by a panel of physician experts (the Editors). The Editors associate these terms with particular documents in the corpus as keywords, assigning varying levels of strength based on the relative importance of that search term to the document. For each document, the Editors consider the varying processes a user might go through in search of such a document, and create keywords accordingly. Synonyms, ambiguities, and multiple meanings are taken into account to help ensure that the results list for any particular query reflects the most relevant topics in UpToDate in order of importance. The involvement of medical experts helps to make the UpToDate search engine unique, and helps to provide more precise search results.

Each group of synonyms in the UpToDate vocabulary includes a canonical (highest level parent) term plus a set of child synonyms. For example, the canonical term “Adenosine deaminase” has several synonyms including “CSF adenosine deaminase”, “Cereborospinal fluid adenosine deaminase”, “Pericardial fluid adenosine deaminase”, and “Pleural fluid adenosine deaminase”. Note that these terms do not all mean exactly the same thing. Rather, this grouping reflects an editorial judgment that a search for adenosine deaminase should result in a search for a variety of related topics. Thus, terms are not restricted to membership in a single synonym grouping, but rather may be associated with multiple different synonym groups.

The synonym vocabulary has a hierarchical structure, with parent/child (subset) relationships. For example, in this embodiment, the UpToDate search engine recognizes that “aspirin” is a child synonym to “antiplatelet agent”. When the more general term is queried, the child terms are also included in the set of search terms used by the search engine to identify relevant documents. Thus, a search for “antiplatelet agent” will also use “aspirin” as a synonym. However, a search for “aspirin” or other child synonym will not encompass a more general, higher level synonym. Instead, in this embodiment, the system will search for “aspirin” and its child or sibling synonyms, and the user interface will suggest that a broader term might be used instead, as shown in FIG. 4. K-stemming or other suitable techniques may be used to expand the synonym list for one or more synonym groups.

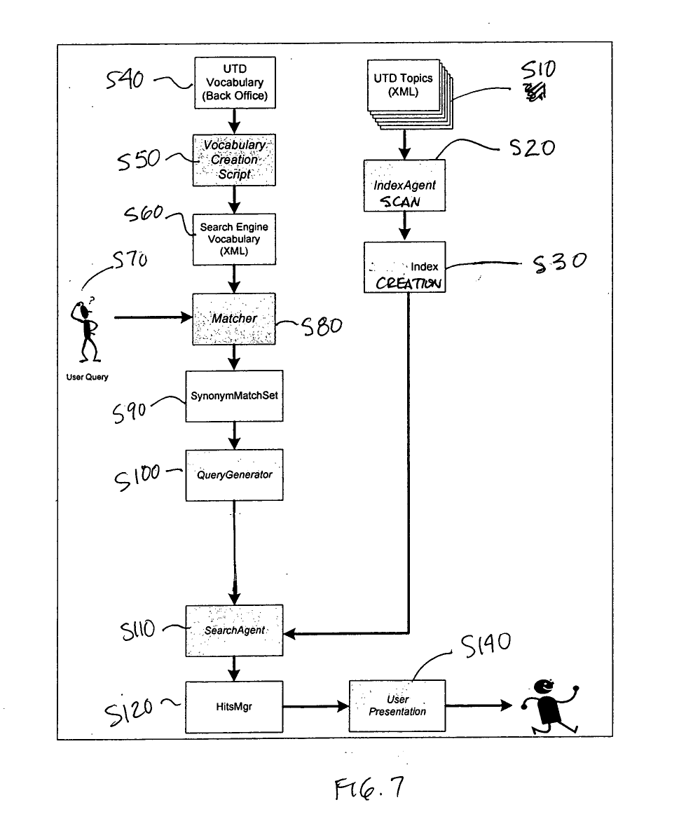

In this illustrative embodiment, the search engine module 32 and document searching index 34 are based on Lucene, an open source, cross-platform search engine library written in Java. However, other suitable platforms may be used. FIG. 6 shows a functional overview of the search method used in this embodiment. Whenever UpToDate content (i.e., documents in the medical information resource 31) is modified, various portions of the documents are scanned and information gathered therefrom is incorporated into the document searching index 34. In this embodiment, terms from document sections including title, headings, text, document type, and keywords are each incorporated into the index 34. When the user provides a search string to the search engine module 32, a matching process generates a set of search terms to identify relevant documents using the index 34, and results are presented to the user by the search results module 33.

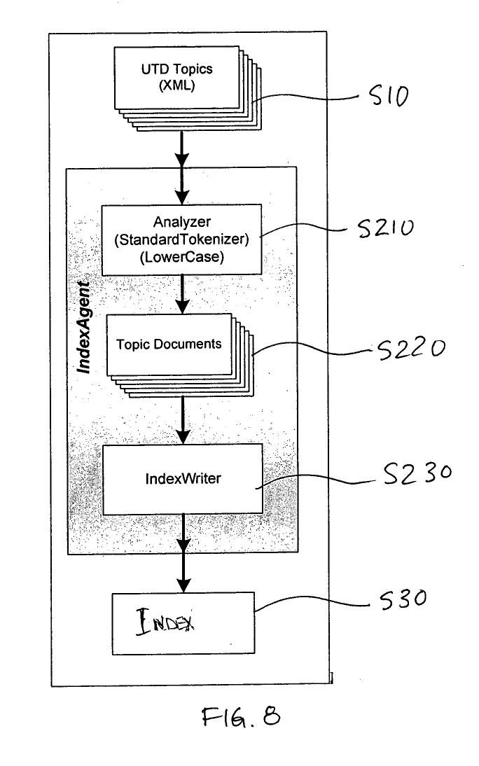

FIG. 7 shows a flow chart of steps for forming an index and synonym grouping, as well as using a user search query to identify relevant documents and provide search results to the user. In this embodiment, in step S10 medical care-related documents are stored as a collection of XML documents. In step S20, IndexAgent software that forms part of the document searching index module 34 periodically scans these documents and in step S30 creates the document searching index used by the search engine module 32.

In step S40, editors (a human expert panel) maintain the medical vocabulary for the system 3, including terms commonly entered by users in search queries and their synonyms. This vocabulary may be maintained as a text document, in a database format (flat file, relational, etc.), or other suitable arrangement. As new terms are coined and/or meanings of terms refined, the editors may suitably adjust the vocabulary. In step S50, a vocabulary creation script that forms part of the search engine module 32 periodically scans the vocabulary, and in step S60 creates a Search Engine Vocabulary which includes groups of associated synonym terms in a hierarchical structure as discussed above. In this embodiment, the Search Engine Vocabulary is stored in an XML format, but other suitable formats may be used.

In step S70, when a user wishes to conduct a search, a search query is provided to the search engine 32 and is processed by a Matcher process in step S80. In this embodiment, the Matcher endeavors to relate the user's query to the Search Engine Vocabulary. For example, if the user provides the search query “MCV”, the Matcher will review the Search Engine Vocabulary and recognize this query as “Mean corpuscular volume”, along with other synonyms associated with “MCV”. As discussed above, if “MCV” is the highest level parent synonym for a group of synonyms, all child synonyms may be identified for use in the subsequent search. Alternately, if “MCV” is a lower level synonym, sibling and child synonyms may be identified for use in the index searching, and higher level parent synonyms may be identified for possible selection/substitution by the user. In step S90, the result of this matching process is temporarily stored in a data structure called SynonymMatchSet, and defines the set of search terms that the search engine module 32 will use to identify documents relevant to the search query.

In step S100, a QueryGenerator that is part of the search engine module 32 converts the SynonymMatchSet (set of search terms) into a structure suitable for searching the document searching index formed in step S30. In step S110, a SearchAgent conducts the search using the query generated in step S100 and, in step S120 places the results in a HitsMgr. The HitsMgr may maintain information for all or many documents in the document searching index 34 regarding which section of the document search terms were located in.

The SearchAgent may execute searches using the set of search terms twice, e.g., once for an “AND” search and again for an “OR” search. “AND” results may be listed by the search results module 33 above “OR” results. For example, if a user query contains two terms that are incorporated into the set of search results used by the search engine module 32, results containing both terms will be listed above results containing only one of the terms. The IDF (inverse document frequency) for the most common synonym in a set may be applied to all synonyms in the set of search terms. Modifiers such as “diagnosis”, “treatment”, and “prevention” may be given special treatment by the search engine. If one of these modifiers is included as part of a search query, the search engine may look for the modifying term in the titles and headings of the result set of documents. For example, if a search query includes “Treatment of tuberculosis”, the search engine may find all results for “tuberculosis”, and then give preference to documents with the word “treatment” in the title or headings sections.

In step S140, using the information in the HitsMgr, search results are generated by the search results module 33 and are displayed to the user, e.g., as an ordered list of document titles like that shown in FIG. 2. The search results module 33 may use information, such as the section in which search terms were found for the documents in generating a suitable display of results.

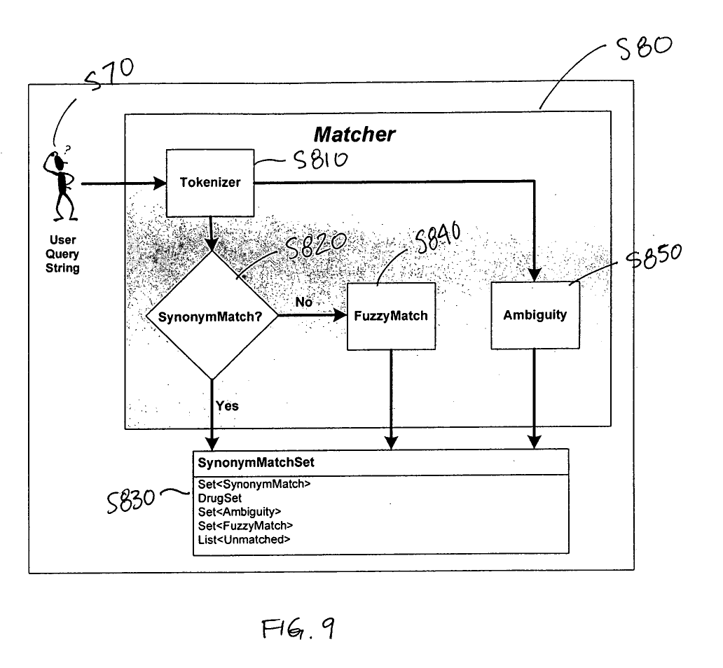

FIG. 8 shows a flowchart of additional detailed steps used to form the document searching index 34 in this embodiment. In step S210, the IndexAgent scans the medical information resource 31 created in step S10 so that information from the documents is tokenized and converted to lower case by an Analyzer process. This produces, in step S220, a set of documents in a format that is suitable for an IndexWriter to produce a Lucene index in step S230. The IndexWriter in this embodiment scans different portions of each document to create a Lucene index, namely:

Title: Each token in the title becomes a searchable term, but if the user enters a complete title as a search query, in general the corresponding document should appear at or near the top of the results list. In general, stop words (such as “an” and “the”) are not included in the index, but may be included if desired.

Keywords: In this embodiment, each document potentially has four Keyword sections, i.e., Keyword1, Keyword2, Keyword3, Keyword4. For each document, keywords may be identified by the Editors and given a level (1-4) based on their strength. The keywords may then be tokenized and added to the index. When a user's query is matched against the index, any topics that have the query term (or synonym) as a 1-level keyword in general will appear higher on the search results list than those with the query term as a 2-, 3-, or 4-level keyword, all other things being equal.

Headings: Document headings are tokenized and indexed. Stop words may or may not be included.

Type: One or more indicators of whether the document is related to Pediatrics, Patient Information, Overview, or Guidelines may be assigned by the Editors and/or automatically determined. For example, any document with a title containing the string “patient information” may be given the type “patient information.” A single document can have multiple types.

Text: The actual text of each document is also tokenized and indexed, excluding designated stop words such as “and” or “the”. This allows a user to search on a term and generate a list of documents in which the term appears, even if the Editors have not designated the term as a keyword or if the term was not included it in the title or outline.

Each of these document sections are tokenized and indexed in the document searching index 34. In addition, the document Title and FileID are stored in the index. The title enables a description of the topic to appear rapidly in the user interface, e.g., as part of the search results list. The FileID enables the system 3 to support access to the document itself, such as when the document is selected by the user from a search results display. In this embodiment, the index is loaded into memory at run-time, but may be loaded or otherwise used in various suitable ways.

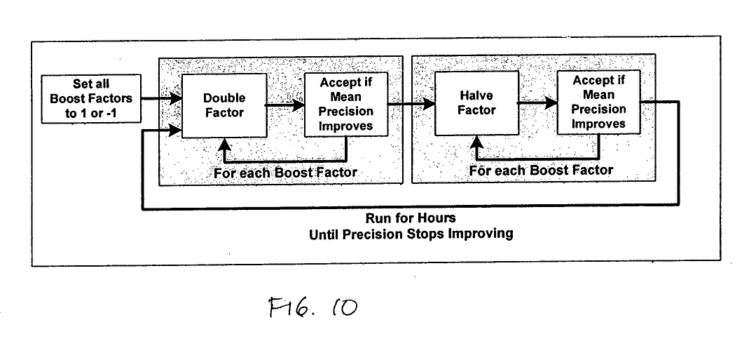

FIG. 9 shows a flowchart of additional detailed steps used to analyze a user's search query and develop a set of search terms used to identify relevant documents in this embodiment.

When a user enters a search query in Step S70, the Matcher compares the query to the search engine vocabulary and searches for matches between one or more terms in the search query and terms in the vocabulary. In the first step of the matching process (step S810), the Tokenizer breaks down the string input by the user into lower case tokens. A spell-checker may be run on the tokens extracted from each user query, e.g., two spell-checkers may be used such as gspell from the National Library of Medicine, and ngrams from the Lucene sandbox. If there is no exact match for a query, the search engine module 32 may present a message asking “Did you mean . . . ?” to the user with the closest match(es) from the spell checker. If both spell checkers identify the same word in their dictionaries as the closest match, then only this result is presented to the user. If the spell checkers differ, multiple options may be presented. In step S820, SynonymMatch then looks for exact matches between the tokens and terms in the search engine vocabulary. In this embodiment, for a four-token string A-B-C-D, SynonymMatch will check, in order, A-B-C-D, A-B-C, B-C-D, A-B, B-C, C-D, A, B, C, D. D-B-C is considered a match for B-C-D, but the system will not check for A-B-D. As soon as a match is found, matching tokens are removed from the search and the process is repeated with the remaining tokens. (Of course, it will be understood that other techniques may be used to identify synonyms or otherwise related terms to terms provided in a user query.) In step S820, SynonymMatch may use Porter stems, with unstemmed matches given priority. Once a match is found, the matched term, along with all parents and children, are added to SynonymMatchSet list under the set<SynonymMatch> in step S830. In the case of a match, the canonical term and all synonyms for the matched term may be added to the SynonymMatchSet. Certain modifier terms, such as “Treatment” and Diagnosis”, may also be identified in this step, as discussed in more detail subsequently. If a match identified in step S820 is a drug, the matched term is added to the DrugSet grouping in SynonymMatchSet. In such a case, the search results module 33 may present the drug-related documents first or otherwise indicate the documents are highly relevant. The same technique may be used for labs.

If a match is not found, in step S840, FuzzyMatch identifies cases in which the user query does not include tokens in the search engine vocabulary. For example, “Tumor necrosis factor receptor associated periodic syndrome” may be a vocabulary term included in the search term vocabulary. SynonymMatch requires that the user enters all seven tokens for a match. FuzzyMatch is more forgiving, but might also find multiple matches for the same tokens. Matches identified by FuzzyMatch in step S840 are added to the SynonymMatchSet under set<FuzzyMatch>, i.e., search terms from the search engine vocabulary that “match” the user's search query term(s) are added to SynonymMatchSet.

Ambiguities may also be identified by the Matcher in step S850, including situations in which one or more terms in the user's search query has multiple meanings. In such a case a preferred term may be substitued into the set of search terms (under set<Abmiguity>) in step S830 for the original search query term. For example, “AI” (Aortic Insufficiency) provided in the original search query may be replaced by the preferred term, “Aortic Regurgitation”. Tokens that do not match any vocabulary terms are placed in a list of Unmatched terms (list<Unmatched>). Together, the SynonymMatch, DrugSet, Ambiguity, FuzzyMatch and Unmatched lists form a set of search terms that may be used by the search engine module 32 to find relevant documents in the medical information resource 31 via the document searching index 34.

The search results module 33 may use boost factors, e.g., as supported by Lucene, to adjust the relative importance of identifying search terms in various document sections, such as Title, Keyword1, Keyword2, Keyword3, Keyword4, Text, Headings, and Document Type (Pediatrics, Patient Information, Overview, Drug, Guidelines). Boost factors may be set automatically in the system tuning process, described below.

To train the system to provide high quality search results, a database of user queries, e.g., 2000 or more, may be identified, and for each query, an expert physician and/or the Editors may identify a set of documents that should result from a search using the query. Precision of the system may be scored in reference to this set of queries based on the results provided. If the system gives prominence to the same documents that were handpicked by the experts for a given query, the precision may be said to be “high”. If one or several of those handpicked topics appear in a low position, the precision may be said to be “low”.

A calculation of the precision of the system operation may be determined using a case where multiple documents are known to be relevant to a particular query. In this embodiment, a metric having a range of 0 to 1 is used, where 1 is “perfect” and 0 indicates that none of the relevant documents were found. In a basic case, all documents known to be relevant to a query may be designated as equally relevant (although in other embodiments, the documents may be ranked). Thus, in this case, if three documents were known to be relevant to a query, a perfect score of 1 would be achieved if these three documents appear in the first three positions on the search results display. Mean Average Precision may be used to measure precision in this case. For example, if there are three relevant documents, there may be three precision values: 1/x, 2/y, and 3/z, where “x” is the rank of the first relevant, “y” is the rank of the second, and “z” the rank of the third. The average of these values gives the average precision for the query.

A more complicated case is where there are multiple relevant documents for a particular query and there are different levels of relevance for the documents. That is, in an ideal case, some of the relevant documents should be listed before others. For example, Editors may prefer that documents having a hit of a search term in the document type section of “Guidelines” be listed before documents having a hit of “Patient Information.” In this example, there are two classes of relevance, that is, three classes of documents: very relevant, relevant, and non-relevant. The description below can be easily generalized to more classes of relevance.

Preference relations may also be used to calculate precision. In this approach, documents may be identified to be preferred over other documents. For example, it could be specified that each relevant document is preferred to every non-relevant document. It could also be specified that some relevant documents are preferred to others, reflecting a multi-level relevance judgment. The preference A>B indicates that A is preferred to B, so a system that puts A closer to the start of the ranked list is satisfying the preference. Note that preferences do not say anything about the degree of preference.

In a system with two classes of relevance, three sets of documents may be defined: a set of very relevant (R1) documents, a set of relevant (R2) documents, and a set of non-relevant (NR) documents. The preference relation is R1>R2>NR. That means that an ideal system will put all documents in R1 before those in R2 and those will be before all in NR.

To understand how preference relations might be implemented, consider the case with only one level, so that R>NR. Suppose there are 4 relevant documents (R) and 10,000 that are not relevant (NR). If the 4 relevant documents appear in the top 34, that means that 9,970 were correctly ranked below the 4 relevant documents, or that 4*9970=39,880 (i.e. most) of the preference relations are satisfied.

In this embodiment, the number of members of NR considered may be restricted, using the top-ranked |R|+10 members of NR for these purposes. (10 is an arbitrarily chosen constant that works well in some empirical studies in the literature.)

Using the same example as above, R has 4 members but only 14 members of NR (the most highly ranked for this query) are used to determine precision. Thus, there are only 56 preference relations under consideration. Suppose that the 4 R members appear in positions 3, 6, 11, and 34 of the search results display. In this case, 12+10+6+0=28 of the preference relations are satisfied, giving a score of 28/56=0.50.

As an additional factor, suppose that the relevant document in the 6th position is preferred to the other 3 relevant documents. This adds 3 relevance relations, 2 of which are satisfied. If the two types of relevance relations are equally weighted, the revised score would be (28+2)/(56+3)=0.51.

As noted previously, boost factors may be used to adjust the relative importance of search term hits regarding document sections Title, Keyword1, Keyword2, Keyword3, Keyword4, Text, Headings, and/or Document Type. FIG. 10 shows a flow diagram for adjusting boost factors for search term hits in one illustrative embodiment. The tuning (or “stepping”) process may begin by setting all boost factors to 1 or −1, depending on whether the factor is intended to promote vs. demote the parameter. Then each boost factor may be doubled, and the system caused to operate for a set of sample queries. The mean precision may be calculated across for each of the set of queries, and a determination may be made whether a change each boost factor had an effect on system performance. If the change in the boost factor improves the precision of the search results provided for a query, the change is accepted, and vice versa. This process is run for each boost factor. The process may be repeated, attempting to halve each boost factor. This stepping process is run iteratively, e.g., “overnight,” until precision stops improving, indicating convergence.

In this embodiment, the stepping process automatically adjusts 12 boost factors that are used by SearchAgent in assessing relevant documents using the document searching index 34. The data set used in this embodiment includes about 2,000 queries where the “correct” search results list has been handpicked by the Editors. Precision is measured based on how well the system matches the Editors' selection.

A study was conducted where 2,000 queries were randomly and evenly divided into Group A and Group B queries. The stepping process was then used to optimize boost factor settings. This was first done three times, once for the A group, once for the B group, and finally for both groups combined.

Results are shown in Table 1 below.

| Boost Factor | A stepping | B stepping | A + B stepping |
|---|---|---|---|
| Text Section | 4.0 | 16.0 | 32.0 |
| Title Section | 2.0 | 1.0 | 2.0 |
| Headings Section | 0.5 | 0.5 | 0.5 |
| Keyword1 Section | 2.0 | 2.0 | 4.0 |
| Keyword2 Section | 2.0 | 2.0 | 2.0 |
| Keyword3 Section | 1.0 | 1.0 | 1.0 |
| Keyword4 Section | 0.5 | 1.0 | 1.0 |
| Title Section | 2.0 | 8.0 | 1.0 |
| Guidelines type in Document | −16.0 | −32.0 | −32.0 |
| Type Section | | | |
| Overview type in Document | 2.0 | 2.0 | 2.0 |
| Type Section | | | |
| Patient Information type in | −16.0 | −128.0 | −128.0 |
| Document Type Section | | | |
| Pediatric type in Document | −0.25 | −0.0625 | −0.5 |
| Type Section | | | |

We then used these parameters to calculate average precision.
A Stepping applied to B queries: 0.766590
B Stepping applied to A queries: 0.758727
A + B Stepping applied to A + B queries: 0.763108
All parameters @ 1.0 applied to A + B queries: 0.734868

This indicates that the stepping does indeed improve precision, and that overfitting did not occur.

Once the stepping procedure is applied, histograms of precision values may be reviewed, and low-scoring queries may be analyzed. In most cases, individual low-precision queries can be addressed by expanding the vocabulary and/or adding keywords to certain documents.

Keywording the documents has been shown to improve the precision of the search engine. A test was run where keywords were excluded from both the stepping procedure, resulting in approximately a 8% decrease in average precision. A second test was run where only the Keyword3 and Keyword4 sections were excluded, which resulted in a less dramatic decrease of 3%. This is a promising finding, as relatively little editorial effort is involved in the maintenance of Keyword1 and Keyword2 sections.

Each of the modules 31-35 of the medical information system 3 may include suitable computer data storage devices, computer useable data (such as text, graphics or other information in any suitable database, file or other format), communication devices to enable communication within the module and with other modules over a communications link using any suitable communications protocol, data processing devices (such as one or more computer processors), software or other suitable instructions for carrying out the various functions of the module, user input/output devices (such as user pointing devices, a touch screen, printer, computer display, and so on) and/or any other components or devices. The modules may be located in a single computer, or may be distributed (either in whole or in part) across multiple devices. Thus, the system 3 need not be located in a single location, but instead may be formed by a plurality of different, physically separate components.

While aspects of the invention have been described in conjunction with specific embodiments thereof, it is evident that many alternatives, modifications, and variations will be apparent to those skilled in the art. Accordingly, embodiments of the invention as set forth herein are intended to be illustrative, not limiting. Various changes may be made without departing from the spirit and scope of the invention.

1. A computerized medical information system, comprising:
a medical information resource including a plurality of documents, each of the plurality of documents relating to providing medical care for a patient;
a document searching index including information for each of the plurality of documents and used for searching and identifying documents that are relevant to a search query, the information for each of the documents including document words located in a plurality of document sections including title, headings, keywords, text and document type;
a search engine that receives a search query from a user and generates a set of search terms from the search query, the search engine using the set of search terms and the document searching index to identify documents that relate to the search query, the set of search terms including at least one term;
a search results module that provides a display of search results to the user based on documents identified by the search engine, wherein the search results module ranks documents in the display of search results based on at least one document section in which the search engine identified at least one term from the set of search terms.

2. The system of claim 1, wherein each of the plurality of documents includes a plurality of keyword sections.

3. The system of claim 1, wherein the document type section includes guidelines, overview, patient information, drug and pediatric types.

4. The system of claim 1, wherein the search query includes at least one term, and the search engine analyzes at least one term in the search query to identify one or more synonyms for the at least one term, and wherein the search engine includes at least one synonym for the at least one term in the set of search terms.

5. The system of claim 4, further comprising a search term synonym resource comprising a plurality of search terms that are associated as synonyms with each other.

6. The system of claim 5, wherein search terms associated as synonyms in the search term synonym resource are arranged in a hierarchical structure such that at least one of the search terms is identified to be a parent synonym to at least one other associated child search term.

7. The system of claim 6, wherein the search engine includes child synonym search terms in a set of search terms for a search query when the search query includes the associated parent synonym search term.

8. The system of claim 6, wherein a human expert panel establishes parent and child synonym relationships for search terms in the search term synonym resource.

9. The system of claim 1, wherein at least one term included in the keyword information for each of the plurality of documents is selected by a human expert panel.

10. The system of claim 1, wherein the search results module uses boost factors for each of the document sections to rank documents in the display of search results.

11. A computerized medical information system, comprising:
a medical information resource including a plurality of documents, each of the plurality of documents relating to providing health care;
a document searching index including information for each of the plurality of documents and used for searching and identifying documents that are relevant to a search query;
a search engine that receives a search query from a user and generates a set of search terms from the search query, the set of search terms including at least one term and the search engine using the set of search terms and the document searching index to identify documents that relate to the search query, wherein the search engine includes a search term synonym resource comprising a plurality of search terms that are arranged in groups of associated synonyms, wherein synonyms in an associated group are arranged in a hierarchical structure such that each synonym in the associated group has a parent, sibling or child relationship with each other synonym in the associated group, and wherein the search engine uses the search term synonym resource to identify at least one synonym search term that is associated as a synonym with at least one term in the search query and includes the at least one synonym search term in the set of search terms; and
a search results module that provides a display of search results to the user based on documents identified by the search engine.

12. The system of claim 11, wherein the search engine includes in the set of search terms only sibling and child synonyms for a term in the search query that is identified to be included in a group of associated synonyms.

13. The system of claim 11, wherein the search engine suggests the use of a parent synonym in the set of search terms when the search query includes a term that is identified to be a child synonym of the suggested parent synonym.

14. The system of claim 11, wherein the document searching index includes information for each of the documents including document words located in a plurality of document sections including title, headings, keywords, text and document type.

15. The system of claim 14, wherein the search results module ranks documents in the display of search results based on at least one document section in which the search engine identified at least one term from the set of search terms.

16. The system of claim 14, wherein each of the plurality of documents includes a plurality of keyword sections.

17. The system of claim 14, wherein the document type section includes guidelines, overview, patient information and pediatric types.

18. The system of claim 14, wherein at least one term included in the keyword information for each of the plurality of documents is selected by a human expert panel.

19. The system of claim 14, wherein the search results module uses boost factors for each of the document sections to rank documents in the display of search results.

20. The system of claim 11, wherein if a term included in the search query has two or more definitions, the search engine automatically selects a preferred definition search term and uses the preferred definition search term in the set of search terms.

21. The system of claim 11, wherein the groups of associated synonyms and the hierarchical structure for each associated group is defined by a human expert panel.
